(19) United States
(12) Patent Application Publication
(10) Pub. No.: US 2011/0113478 A1
(43) Pub. Date: May 12, 2011

(54) METHOD OF SECURING FRANKING VIA A TELECOMMUNICATIONS NETWORK

(75) Inventor: Fabien CHATTE, Nogent Sur Marne (FR)

(73) Assignee: NEOPOST TECHNOLOGIES, Bagneux (FR)

(21) Appl. No.: 12/876,650

(22) Filed: Sep. 7, 2010

(30) Foreign Application Priority Data
Nov. 10, 2009 (FR) 0957942

(51) Int. Cl. H04L 9/32

(52) U.S. Cl. 726/7

(57) ABSTRACT

A method of securing franking, said method comprising the following operations:
a user writing a personal secret code by hand on a mailpiece bearing a unique identification number;
a portable communications device acquiring said personal secret code and said unique identification number that are borne by said mailpiece;
sending said secret code and said unique identification number as acquired by said portable communications device to a remote computer server; and
comparing said personal secret code as received with a personal secret code of said user pre-recorded in said remote computer server.

### TECHNICAL FIELD

The present invention relates exclusively to the field of mail handling and it relates more particularly to a method of securing franking via a telecommunications network.

### STATE OF THE ART

Nowadays, when a private individual or a very small business not equipped with a franking machine wishes to frank mail, it is necessary, possibly after weighing, to stick a stamp on each envelope or parcel to be sent. An alternative that does not however apply to parcels can consist in purchasing pre-franked envelopes, but that is applicable only to letters that are posted at a standard base price.

That long-unsatisfied need was addressed by the Applicant's Application FR 2 890 769 that disclosed a revolutionary franking method accessible by anybody 24 hours a day, 365 days a year, applicable both for envelopes and for parcels, and particularly simple to implement both for the postal authority and for the sender. Unfortunately, in use, a security loophole has appeared, and the present application proposes to remedy that security problem. In the event that the sender's portable communications device or the Subscriber Identity Module (SIM) card associated therewith is stolen, the postage amounts for mailpieces franked by the thief using the sender's device or SIM card can be debited directly from the sender's account.

### DISCLOSURE OF THE INVENTION

An object of the present invention is to mitigate the above-mentioned drawback by proposing a method of securing franking via a telecommunications network for a sender equipped with a portable communications device, said method comprising the following operations:
a user writing a personal secret code by hand on a mailpiece bearing a unique identification number;
a portable communications device acquiring said personal secret code and said unique identification number that are borne by said mailpiece;
sending said secret code and said unique identification number as acquired by using said portable communications device to a remote computer server; and
comparing said personal secret code as received with a personal secret code of said user pre-recorded in said remote computer server.

In this way, by adding a secret code that is known to the user alone, stealing the portable communications device or the SIM card that it contains no longer enables the thief to obtain franking without having first made the payment therefor. In addition, writing the secret code in graphic form directly onto the mailpiece also enables the postal authority, in the event that the unique identification number borne by the mailpiece is copied by a person usurping the identity of the user, to check which article has been franked by the holder of the account and thus to reject the counterfeit other mailpiece.

Depending on the implementation, the operation of writing said personal secret code consists in forming a graphic symbol in a defined space on said mailpiece or in writing a string of characters in a defined space on said mailpiece.

Preferably, the operation of acquiring said personal secret code and said unique identification number consists in digital capture by the user's portable communications device.

Preferably, the operation of sending said personal secret code and said unique identification number from the portable communications device comprises sending a Short Message Service (SMS) text message including at least said personal secret code and said unique identification number.

Advantageously, the operation of comparing said personal secret codes is performed with the phone number of said portable communications device being known.

The invention also provides a portable communications device for implementing the method of securing franking, said portable communications device advantageously being constituted by any one of the following devices: a mobile telephone or a cellphone, a smartphone or a communicating personal digital assistant (PDA), or a communicating laptop computer.

The invention also provides a computer program including code instructions for performing the steps of the method of securing franking when said program is executed on the above-mentioned portable communications device.

### BRIEF DESCRIPTION OF THE DRAWINGS

Other characteristics and advantages of the present invention appear more clearly from the following description given by way of non-limiting indication, with reference to the accompanying drawings, in which:

FIG. 1 shows an example of a network architecture making it possible to implement the method of the invention for making it secure to perform franking; and

FIG. 2 is a flow chart explaining the various steps making it possible to implement the method of the invention for making it secure to perform franking over the network shown in FIG. 1.

### IMPLEMENTATION(S) OF THE INVENTION

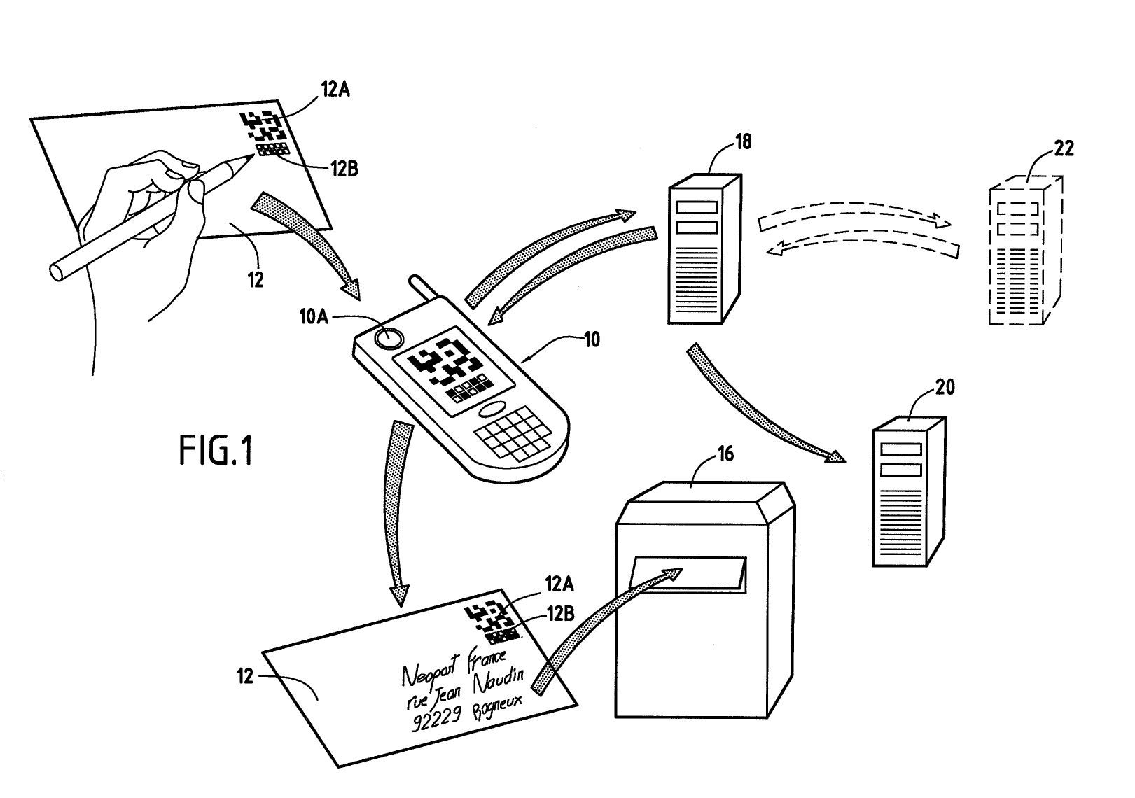

FIG. 1 shows an example of a network architecture necessary for implementing the method of the invention for making it secure to perform franking. The architecture is based on the use of a portable communications device 10 that is used, prior to any franking operation, to input various codes borne by a mailpiece 12 that is to be sent via any one of the postal authority's mailboxes 16. The term “mailpiece” is used to mean not only an envelope but also a label designed to be stuck to any type of parcel to be sent.

For implementing the method of the invention, said mailpiece is previously provided with a unique identification number 12A and with an empty space 12B that is disposed below said number and that is defined, preferably by a box, and in which the sender of the mailpiece (the user) writes a secret code.

The identification number 12A is preferably sequential or of the random type that cannot be drawn again and it is printed during the process of creating the mailpiece, thereby guaranteeing the quality of printing. Said identification number is unique so that two mailpieces cannot bear the same number under any circumstances. It is important to note that, unlike a stamp or a postal imprint printed by a franking machine or “postage meter”, this number does not represent any franking amount and therefore does not contain any monetary value.

Once it is printed, said unique identification number is advantageously in the form of a code having a high capacity for encoding numeric or alphanumeric data with error correction, such as a two-dimensional (2D) bar code, the most well known of which 2D bar codes are Aztec Code, Codablock, Code One, Code 16K, Code 49, Data Matrix, PDF 417, QR Code, or indeed Supercode. The high encoding capacity of that type of code (having up to 4296 characters for the highest-performance codes) thus enables the code to include not only the identification number but also other information relating to the mailpiece, such as a format reference when the mailpiece is an envelope, or indeed a manufacturer number and a country code, as recommended by the Electronic Product Code (EPC) Standard drawn up by the standardization body of the same name.

In the example shown, the empty space 12B may, for example, be made up of a set of empty boxes that should be shaded in by the user using a predefined scheme in order to form a unique graphic symbol representing the user's secret code. Thus, a set of ten boxes, as shown makes it possible to define 1024 different secret codes. By way of an alternative, the empty space may be a blank zone defined merely by a box and in which the user writes the secret code directly in the form of a numeric or preferably alphanumeric code.

During the process of securing franking, the portable communications device is put into communication with a remote computer server 18 preferably belonging to a franking service provider, it being possible for said computer server itself to be put into communication with a server 20 belonging to the postal authority and optionally with a server 22 belonging to a telephone operator optionally debiting franking credit directly from a telephone account that the user of the portable communications device can hold with the telephone operator.

The portable communications device 10 is preferably any data processor device enabling long-distance wireless communications to be set up over a terrestrial or satellite wireless telecommunications network (such as any of the following networks GSM, GPRS, UMTS, WiMax, etc.), such as a mobile telephone or a cellphone, a smartphone or a communicating PDA, or indeed a communicating laptop computer. Depending on the implementation, the portable communications device may include a digital capture device 10A, such as a digital camera or a 2D bar code reader.

The computer server 18 may incorporate one or more computer central processing units having one or more databases and it is controlled and managed conventionally by one or more computer terminals (not shown). The postal authority's server 20 is of similar structure, with one or more databases, in particular a database containing the identification numbers and the secret codes of the users. Likewise, the telephone operator's server 22 is also of similar structure, with one or more databases, in particular a customer database incorporating accounting data.

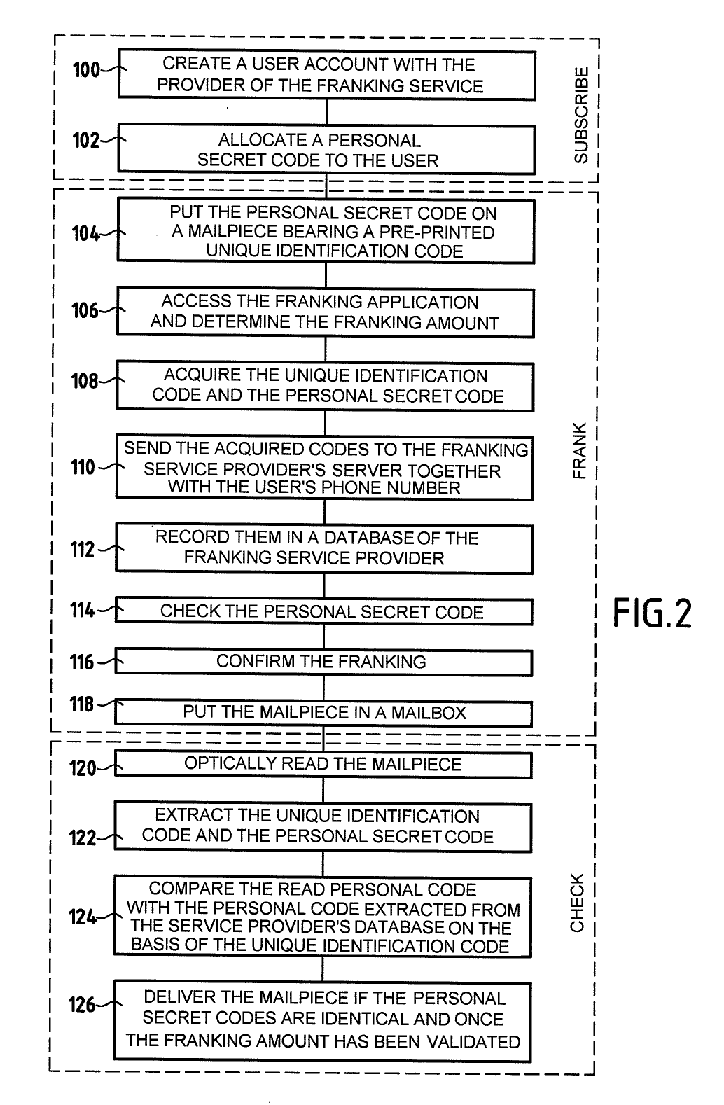

FIG. 2 is a flow chart showing the various steps of the method of securing franking for a user via a telecommunications network.

Implementing the method assumes that a subscription stage has been performed earlier with a franking service provider, that subscription preferably taking place in a first step 100, via the telecommunications network, by accessing said service provider's computer server 18. However, such subscription may also take place by mail or directly at an office of said service provider, the subscription consisting in opening and creating a customer account involving indicating the identity of the user and indicating the telephone number from which the user is subsequently to log into the service. In exchange for this subscription, the service provider, in a following step 102, indicates a personal secret code to the user, making it secure for the user to perform franking. Since the user has then become a customer, said user can then procure blank labels or envelopes directly from said service provider or else from various manufacturers whose details are indicated to the user, each of which labels or envelopes bears a unique identification code (advantageously in the form of a bar code 12A) and a defined space 12B for receiving the personal secret code.

Thus in possession of the personal secret code, the user is then able to frank a mailpiece to be sent to any recipient. This franking stage starts, in a step 104, by putting said personal secret code into the space provided for that purpose on the pre-printed mailpiece that is to be sent. In a following step 106, the user then clicks on the icon of the franking application preinstalled in the portable communications device (if it is not preinstalled, this application is supplied (or downloaded) to the user by the service provider during subscription) and, as is known, via the display screen of the portable communications device, the user chooses the franking service or the franking amount that is desired. This access to the application also automatically activates the digital capture function of the portable communications device that enables the user, via the digital capture means 10A, to capture, in a step 108, an image of the bar code 12A and of the personal secret code 12B that are borne by the pre-printed mailpiece, validation of the capture of said image by acting on a picture-taking button (not shown) of the portable communications device leading to immediate decoding of the captured bar code, i.e. to extraction of the unique identification number contained in said bar code, and of the personal secret code if said personal secret code is in graphic form (e.g. in the form of shaded-in boxes).

The portable communications device then, in a step 110, sends to the franking service provider's computer server 18, e.g. in the form of an SMS text message, the data making it possible to determine the franking amount, as well as the previously extracted unique identification number and the previously extracted personal secret code so that the server records them simultaneously in its database, in another step 112, with the phone number of the portable communications device that sent the data (this phone number being obtained conventionally on the basis of a number recognition service such as the “Calling Line Identification Presentation” service). The franking service provider can then, in a step 114, check that the user is indeed one of its subscribers, and that the indicated personal secret code does indeed correspond to that customer (otherwise the call is terminated), and can confirm the data of the user's franking to the user in a step 116. Once this confirmation has been received, the user can, without any other formality, in a final step 118, go and put the mailpiece in a mailbox after having written the address of the recipient on it as shown in FIG. 1 (naturally, if the address has not already been written on it).

Every day, at the end of the day, preferably in the last few minutes thereof, the franking service provider's computer server 18 transfers to the postal authority's server 20 all of the data relating to the operations performed during the day or, more simply, gives the postal authority the rights to access all of that data on its own server.

Thus, with the present invention, it is very easy for any user to send any mailpiece (envelope or parcel) to any destination without it being necessary for the user to go to an office of the postal authority, since the unique identification number (that replaces the stamp or postal imprint of a franking machine by acting as such a stamp or imprint even though it has no monetary value) borne on each mailpiece and made secure by the user's personal secret code is sufficient for the postal authority then to check said mailpiece.

When the mailpiece is handed over to one of its offices, the postal authority, in a step 120, optically reads the mailpiece so as to extract therefrom, in a step 122, firstly the unique identification number and secondly the personal secret code, and then, on the basis of said identification number, accesses the franking service provider's database (or its own database, depending on whether or not the service provider has passed on to it the contents of it database) so as to retrieve therefrom the associated secret code, so as to compare said secret code with the secret code read off the mailpiece, and thus so as to determine whether or not the mailpiece does indeed come from a subscriber (step 124), this being an essential precondition for delivery of said mailpiece by the postal authority in the final step 126.

Naturally, as is known, and in order to check the franking amount, the recipient's address is also optically read (in order to determine the destination zone) as is any requested service, when such a service is preprinted on the mailpiece, e.g. a “priority” service, and the mailpiece is weighed in order to determine its weight class. On the basis of that information, the franking amount necessary for the mailpiece is then computed so as to compare it with the amount paid by the sender. In the event that the amount paid is insufficient, the postal authority calculates the extra payment that needs to be made by the recipient in order to receive the mailpiece.

It should be noted that although the present invention is described essentially with reference to a mailpiece that bears a unique identification number of the 2D bar code type, it is possible, in a simpler version, for said number to be merely an alphanumeric code formed of a string of one or more tens of alphanumeric characters that is machine readable by means of an Optical Character Recognition (OCR) reader, or that is quite simply input directly by the user on the keypad of the portable communications device.

What is claimed is:

1. A method of securing franking via a telecommunications network for a sender equipped with a portable communications device, said method comprising the following operations:
a user writing a personal secret code by hand on a mailpiece bearing a unique identification number;
a portable communications device acquiring said personal secret code and said unique identification number that are borne by said mailpiece;
sending said secret code and said unique identification number as acquired by said portable communications device to a remote computer server; and
comparing said personal secret code as received with a personal secret code of said user pre-recorded in said remote computer server.

2. A method according to claim 1, wherein the operation of writing said personal secret code consists in forming a graphic symbol in a defined space on said mailpiece.

3. A method according to claim 1, wherein the operation of writing said personal secret code consists in writing a string of characters in a defined space on said mailpiece.

4. A method according to claim 1, wherein the operation of acquiring said personal secret code and said unique identification number consists in digital capture by the user's portable communications device.

5. A method according to claim 1, wherein the operation of sending said personal secret code and said unique identification number from the portable communications device comprises sending an SMS text message including at least said personal secret code and said unique identification number.

6. A method according to claim 1, wherein the operation of comparing said personal secret codes is performed with the phone number of said portable communications device being known.

7. A portable communications device for implementing the method of securing franking according to claim 1.

8. A device according to claim 7, that is constituted by any one of the following devices: a mobile telephone or a cellphone, a smartphone or a communicating PDA, or a communicating laptop computer.

9. A computer program including code instructions for performing the steps of the method of securing franking according to claim 1 when said program is executed on the portable communications device according to claim 8.
